(19) United States
(12) Patent Application Publication
(10) Pub. No.: US 2025/0007024 A1
(43) Pub. Date: Jan. 2, 2025

(54) METHOD FOR REMOVING FLUORINE IN POSITIVE ELECTRODE LEACHATE OF LITHIUM BATTERIES

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Shibao Ouyang, Foshan, Guangdong (CN); Changdong Li, Foshan, Guangdong (CN); Yanchao Qiao, Foshan, Guangdong (CN); Ruokui Chen, Foshan, Guangdong (CN); Dingshan Ruan, Foshan, Guangdong (CN); Yong Cai, Foshan, Guangdong (CN)

(21) Appl. No.: 18/695,824

(22) PCT Filed: Jul. 29, 2022
(86) PCT No.: PCT/CN2022/109230

§ 371 Date: Mar. 27, 2024

(30) Foreign Application Priority Data
Oct. 26, 2021 (CN) 202111246998.X

(51) Int. Cl. H01M 10/54; C01F 7/54; C22B 3/22; C22B 7/00

(52) U.S. Cl. CPC H01M 10/54; C01F 7/54; C22B 3/22; C22B 7/007; C01P 2006/80

(57) ABSTRACT

Disclosed is a method for removing fluorine in a positive electrode leachate of lithium batteries, comprising: adding acid and an oxidizing agent to battery powder for leaching, and removing impurities from the obtained leachate to obtain a fluorine-containing solution; adding dawsonite to the fluorine-containing solution, and meanwhile adding sulfuric acid, stirring for reaction at a certain temperature, and performing solid-liquid separation to obtain fluorine-removed solution and filter residues; and washing the filter residues to obtain crude sodium hexafluoroaluminate. According to the present invention, the dawsonite is used for removing fluorine from waste lithium batteries, the dawsonite has good selectivity, does not react with nickel, cobalt, manganese, lithium and the like in the solution, and only reacts with fluorine ions in the solution, so that the purpose of selectively removing fluorine is achieved, and the loss of nickel, cobalt, manganese and lithium metals in the solution is avoided.

### TECHNICAL FIELD

The present disclosure relates to the technical field of recycling waste battery, and specifically, to a method for removing fluorion in cathode leaching solution of a lithium battery.

### BACKGROUND

Due to the high energy density, long cycle life, no memory effect, high rated voltage, and low self-discharge rate, lithium batteries have been widely used in mobile phones, notebook computers and new energy vehicles, and are known as the development direction of energy storage battery in the future. With the continuous development of the global economy, the demand for lithium batteries will further increase. It is expected that the global lithium battery production growth rate will remain 10% or more every year. However, lithium batteries have a service life. According to statistics, the total number of discarded batteries all over the world in 2020 will exceed 25 billion, with a mass of 500,000 tons. Therefore, the recycling and treatment of discarded lithium batteries has also become an urgent problem to be solved.

Since the lithium battery itself contains an electrolytic solution comprising lithium hexafluorophosphate, and sodium fluoride is added to remove impurities such as calcium and magnesium when leaching and recovering metals such as nickel, cobalt, manganese and lithium, it is inevitable that fluorion will be introduced into the leaching solution of waste lithium batteries. At present, there are few reports on the process of removing fluorion in the leaching liquid of waste lithium batteries. In the traditional process, the nickel, cobalt and manganese is first extracted from the waste lithium battery with an extractant, with the fluorion left in the raffinate, and then the raffinate is introduced to the water treatment workshop to remove fluorion. However, this process also has a series of problems: (1) part of the fluorion will enter into the solution containing nickel, cobalt and manganese during extraction, resulting in poor quality of the subsequently synthesized precursor product; (2) fluorion will have a certain impact on the subsequent oil removal and COD of the raffinate, resulting in wastewater failing to meet the standard; and (3) the presence of fluorion will cause corrosion of the equipment and shorten the service life of the equipment. In view of some of the above-mentioned problems, it is necessary to develop a new fluorion removal process.

### SUMMARY

The present invention aims to solve at least one of the above-mentioned technical problems existing in prior art. To this end, the present invention proposes a method for removing fluorion in cathode leaching solution of a lithium battery.

According to one aspect of the present invention, a method for removing fluorion in cathode leaching solution of a lithium battery is proposed, comprising the following steps:

S1: adding an acid and an oxidant to a battery powder for leaching, and removing impurities from an obtained leaching solution to obtain a fluorion-containing solution; and

S2: adding dawsonite and sulfuric acid to the fluorion-containing solution for reaction under stirring at a certain temperature, performing solid-liquid separation to obtain a defluorinated solution and a filter residue, and washing the filter residue to obtain crude sodium hexafluoroaluminate.

In some embodiments of the present invention, in the step S1, the oxidant is hydrogen peroxide.

In some embodiments of the present invention, in the step S1, the removing impurities comprises a process of adding sodium fluoride to remove calcium and magnesium. Further, the removing impurity also comprises a process of adding sodium carbonate to remove iron and aluminum.

In some embodiments of the present invention, in the step S2, the dawsonite is prepared by a method comprising the following steps: mixing aluminum powder with a sodium hydroxide solution for reaction, performing filtering to obtain a metaaluminate solution, introducing carbon dioxide gas into the metaaluminate solution for reaction under stirring at a certain temperature until an end-point pH value of a resulting solution is stable in a certain range, then stop stirring, aging the resulting solution for a period of time, and performing filtering to obtain the dawsonite. Wherein, the dawsonite obtained by filtering needs to be washed for 2-3 times with pure water, and then dried at 80° C. to 120° C. for 4 hours to 6 hours. Preferably, a reaction temperature of the aluminum powder and the sodium hydroxide solution is 50° C. to 80° C., and the reaction lasts for 30 min to 60 min; the end-point pH value of the resulting solution is controlled at 5.0-7.0; and the aging is performed for 2 h to 5 h. The reaction formula for the preparation of dawsonite is: 2Al+2NaOH+2H₂O=2NaAlO₂+3H₂ ↑, and NaAlO₂+CO₂+H₂O=NaAlCO₃(OH)_{2 ↓.}

In some preferred embodiments of the present invention, the aluminum powder is obtained by steps of: obtaining aluminum residue after discharging, disassembling, shredding, sorting and sieving of waste lithium batteries, and then finely breaking the aluminum residue and passing through a 100-mesh sieve to obtain aluminum residue powder. The raw material for the preparation of dawsonite is aluminum residue obtained by disassembling waste lithium batteries, which not only has a good fluorion removal effect, but also greatly reduces the cost of fluorion removal.

In some embodiments of the present invention, a solid-liquid ratio of the aluminum powder to the sodium hydroxide solution is 1:(3-5) g/mL, and a concentration of the sodium hydroxide solution is 10% to 30%.

In some embodiments of the present invention, the step of introducing carbon dioxide gas into the metaaluminate solution for reaction is conducted at a temperature of 40° C. to 60° C. Preferably, a stirring rate of the metaaluminate solution is 150 rpm to 350 rpm when the carbon dioxide gas is introduced into the metaaluminate solution.

In some embodiments of the present invention, in the step S2, a molar ratio of aluminum in the dawsonite to fluorion in the fluorion-containing solution is (1-1.3):6.

In some embodiments of the present invention, in the step S2, a flow rate of the added sulfuric acid is 1.0 mL/min to 2.5 mL/min, and a mass concentration of the sulfuric acid is 5% to 10%.

In some embodiments of the present invention, in the step S2, the reaction of the fluoride-containing solution and the dawsonite is conducted at a temperature of 40° C. to 60° C. for 60 min to 90 min; preferably, a stirring rate during the reaction of the fluorion-containing solution and the dawsonite is 100 rpm to 200 rpm.

In some embodiments of the present invention, in the step S2, the end-point pH value of the reaction of the fluorion-containing solution and the dawsonite is controlled at 5.0-6.0, preferably 5.5. Adjusting the end-point pH value of the reaction to a certain range, the aluminum dissolved from the dawsonite can only exist in the form of sodium hexafluoroaluminate and aluminum hydroxide, and there is no free aluminum ion, so as to ensure that no impurities are introduced into the solution after defluoridation. For the residue after defluoridation, unreacted dawsonite and aluminum hydroxide can be dissolved to obtain sodium hexafluoroaluminate with higher purity through adjusting a pH value.

In some embodiments of the present invention, in the step S2, the defluorinated solution is subjected to extraction treatment to obtain a nickel cobalt manganese sulfate solution product.

In some embodiments of the present invention, the step S2 further comprises: pulping the crude sodium hexafluoroaluminate with water, adding an acid to adjust a pH value of a resulting slurry to dissolve a small amount of impurities, and then filtering the slurry, washing and drying an obtained solid to obtain high-purity sodium hexafluoroaluminate. The impurities are excess dawsonite and sodium hydroxide, and the principle of impurity removal is: NaAlCO₃(OH)₂+4H⁺→Al³⁺+Na⁺+3H₂O+CO₂ ↑, and Al(OH)₃+3H⁺→Al³⁺+3H₂O.

In some embodiments of the present invention, the acid is added to adjust the pH value of the resulting slurry to 3.0-5.0, and the acid is sulfuric acid with a concentration of 3% to 6%.

In some embodiments of the present invention, a solid-liquid ratio of the crude sodium hexafluoroaluminate to water is 1:(3-5) g/mL.

According to a preferred embodiment of the present invention, it has at least the following beneficial effects.

1. In the present invention, dawsonite is used to remove fluorine from waste lithium batteries. The dawsonite has good selectivity and does not react with nickel, cobalt, manganese, lithium, and the like in the solution, but only reacts with fluorion in the solution, thereby achieving the purpose of selective fluorion removal, and avoiding the loss of nickel, cobalt, manganese and lithium metals in the solution. The removal rate of fluorion is as high as 99%. Fluorion can be removed to 20 mg/L or less, and a concentration of aluminum ions introduced into the solution after fluorion removal is less than 1 mg/L. The purity of sodium hexafluoroaluminate after purification of the fluorion-removed residue reaches 96% or more. The fluorion-removed residue can be used as a cosolvent in the electrolytic aluminum industry, as a pesticide for crops, and as a flux and a cream for enamel and glaze. The potential value of recovery is great.

2. Large fluorion removal capacity. NaAlCO₃(OH)₂+6F⁻+4H⁺+2Na⁺=Na₃AlF₆+3H₂O+CO₂ ↑. From the defluoridation reaction equation, one mole of aluminum can combine with six moles of fluorion, that is, 1 kg of aluminum atoms can be combined with 4.2 kg of fluorine atoms, and the fluorion removal capacity is large. In addition, the sodium ions in the solution are consumed when fluorion is removed, thus the concentration of sodium ions in the solution is reduced, and the quality of the nickel cobalt manganese sulfate solution product is improved.

3. The solution defluorinated by dawsonite is extracted and nickel, cobalt, manganese and lithium are recovered, and then the wastewater is introduced into the water treatment workshop. Since the fluorion concentration is lower, there is no need to remove fluorion again, which avoids corrosion of fluorion on the subsequent process equipment and the effect of fluorion on removing oil from wastewater and COD.

### BRIEF DESCRIPTION OF DRAWINGS

The present invention will be further described below in conjunction with the accompanying drawings and examples, in which:

FIG. 1 is a process flow diagram of Example 1 of the present invention.

### DETAILED DESCRIPTION OF EMBODIMENTS

Hereinafter, the concept and the produced technical effects of the present invention will be described clearly and completely in combination with the examples, so as to fully understand the purpose, features and effects of the present invention. Apparently, the described examples are only part of the examples of the present invention, not all of the examples. Based on the examples of the present invention, other examples obtained by those skilled in the art without creative work belong to the scope of protection of the present invention.

### EXAMPLE 1

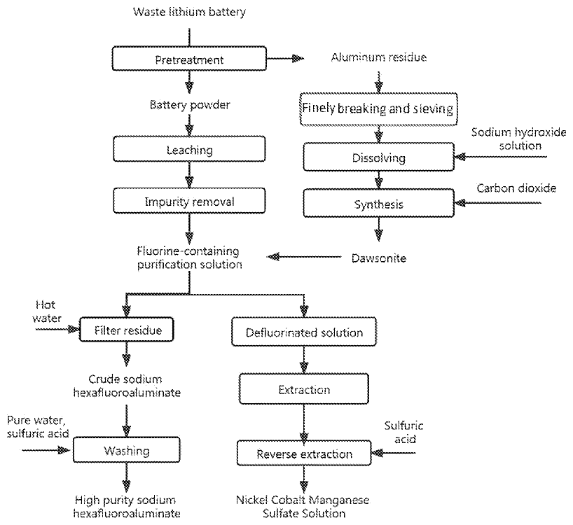

A method for removing fluorion in cathode leaching solution of a lithium battery was provided, referring to FIG. 1, and the specific process was as follows.

(1) Pretreatment: after discharging, the waste lithium battery was disassembled, shredded, sorted and sieved to obtain battery powder and aluminum residue.

(2) Preparation of dawsonite defluorinating agent: based on the step (1), the aluminum residue was finely shredded and passed through a 100-mesh sieve to obtain aluminum residue powder; the obtained aluminum residue powder and 10% sodium hydroxide solution were mixed according to a solid-liquid ratio of 1:5 g/mL, stirred and reacted at 80° C. for 60 min; after the reaction, the solution was filtered to obtain insoluble residue and sodium metaaluminate solution; the insoluble residue was transferred to step (3) for acid leaching and dissolution; the sodium metaaluminate solution was introduced with carbon dioxide gas for reaction at a reaction temperature of 40° C., and a stirring rate of 150 rpm. The stirring and introducing carbon dioxide gas were not stopped until a pH value of the solution stabilized at 6.0. The solution was aged for 2 h, then filtered, and the filter residue was washed twice with pure water. After dried for 4 hours in a drying oven at 80° C., dawsonite was obtained.

(3) Battery powder leaching and impurity removal: the battery powder obtained from the step (1) was pulped with pure water, and then leached with sulfuric acid and hydrogen peroxide; after impurity removal, 2.2 L of fluorion-containing purified solution was obtained, and impurity removal comprised adding sodium carbonate to remove iron and aluminum and adding sodium fluoride to remove calcium and magnesium. The components and contents of the fluorion-containing purified solution were shown in Table 1.

TABLE 1
Components and contents of fluorion-
containing purified solution (g/L)

| Ni²⁺ | Co²⁺ | Mn²⁺ | Li⁺ | Na⁺ | F⁻ |
|---|---|---|---|---|---|
| 32.37 | 7.95 | 11.25 | 2.34 | 19.72 | 2.43 |

(4) Selective fluorion removal by adding dawsonite: based on the steps of (2) and (3), to the fluorion-containing purified solution, defluorinating agent dawsonite was added in an amount wherein a molar ratio of aluminum in the dawsonite to fluorion in the purified solution was 1.1:6. At a stirring rate of 100 rpm and temperature of 40° C., 5% sulfuric acid was introduced through a peristaltic pump at a flow rate of 1 mL/min, and the reaction was carried out for 90 minutes: an end-point pH value of the reaction was controlled at 5.5: after the reaction, the solution was filtered to obtain 3.1 L of defluorinated solution and filter residue, the defluorinated solution was then subjected to extraction treatment to obtain nickel cobalt manganese sulfate solution product: the filter residue was washed for 2-3 times with hot water to obtain crude sodium hexafluoroaluminate, and the washed water was combined into the defluorinated solution.

(5) Purification of crude sodium hexafluoroaluminate: based on the step (4), the crude sodium hexafluoroaluminate was added to pure water with a solid-liquid ratio of 1:3 g/mL for pulping, and 3% sulfuric acid was added slowly in an agitated state to adjust a pH value of the slurry to 4.0, a small amount of impurities was dissolved: after the reaction, the slurry was filtered to obtain a filter residue, which was then washed by adding pure water for pulping with a solid-liquid ratio of 1:3 g/mL: after filtration, the filter residue was further washed with pure water for pulping with a solid-liquid ratio of 1:3 g/mL once, and filtration was performed to obtain filter residue, which was subjected to drying treatment to obtain high-purity sodium hexafluoroaluminate.

### EXAMPLE 2

A method for removing fluorion in the cathode leaching solution of a lithium battery was provided, and the specific process was as follows.

(1) Pretreatment: after discharging, the waste lithium battery was disassembled, shredded, sorted and sieved to obtain battery powder and aluminum residue.

(2) Preparation of dawsonite defluorinating agent: based on the step (1), the aluminum residue was finely shredded and passed through a 100-mesh sieve to obtain aluminum residue powder: the obtained aluminum residue powder was mixed with 30% sodium hydroxide solution according to a solid-liquid ratio of 1:3 g/mL, stirred and reacted at 50° C. for 30 min: after the reaction, the solution was filtered to obtain insoluble residue and sodium metaaluminate solution: the insoluble residue was transferred to step (3) for acid leaching and dissolution: the sodium metaaluminate solution was introduced with carbon dioxide gas for reaction at a reaction temperature of 60° C., and a stirring rate of 350 rpm. The stirring and introducing carbon dioxide gas were not stopped until a pH value of the solution stabilized at 6.0. The solution was aged for 5 h, then filtered, and the filter residue was washed twice with pure water: and after dried for 4 hours in a drying oven at 100° C., dawsonite was obtained.

(3) Battery powder leaching and impurity removal: the battery powder obtained from the step (1) was pulped with pure water, and then leached with sulfuric acid and hydrogen peroxide: after impurities removal, 1.5 L of fluorion-containing purified solution was obtained, and impurities removal comprised adding sodium carbonate to remove iron and aluminum and adding sodium fluoride to remove calcium and magnesium. The components and contents of the fluorion-containing purified solution were shown in Table 2.

TABLE 2
Components and contents of fluorion-
containing purified solution (g/L)

| Ni²⁺ | Co²⁺ | Mn²⁺ | Li⁺ | Na⁺ | F⁻ |
|---|---|---|---|---|---|
| 27.53 | 12.37 | 13.46 | 2.39 | 18.67 | 2.36 |

(4) Selective fluorion removal by adding dawsonite: based on the steps of (2) and (3), to the fluorion-containing purified solution, defluorinating agent dawsonite was added in an amount wherein a molar ratio of aluminum in the dawsonite to fluorion in the purified solution was 1.3:6. At a stirring rate of 200 rpm and temperature of 60° C., 10% sulfuric acid was introduced through a peristaltic pump at a flow rate of 2.5 mL/min, and the reaction was carried out for 60 minutes; an end-point pH value of the reaction was controlled at 5.5; after the reaction, the solution was filtered to obtain 3.2 L of defluorinated solution and filter residue, the defluorinated solution was then subjected to extraction treatment to obtain nickel cobalt manganese sulfate solution product; the filter residue was washed for 2-3 times with hot water to obtain crude sodium hexafluoroaluminate, and the washed water was combined into the defluorinated solution.

(5) Purification of crude sodium hexafluoroaluminate: based on the step (4), the crude sodium hexafluoroaluminate was added to pure water with a solid-liquid ratio of 1:5 g/mL for pulping, and 6% sulfuric acid was added slowly in an agitated state to adjust a pH value of the slurry to 4.0, a small amount of impurities was dissolved; after the reaction, the slurry was filtered to obtain a filter residue, which was then added to pure water for pulping with a solid-liquid ratio of 1:3 g/mL; after filtration, the filter residue was further washed with pure water for pulping with a solid-liquid ratio of 1:3 g/mL once, and filtration was performed to obtain filter residue, which was subjected to drying treatment to obtain high-purity sodium hexafluoroaluminate.

### EXAMPLE 3

A method for removing fluorion in the cathode leaching solution of a lithium battery was provided, and the specific process was as follows.

(1) Pretreatment: after discharging, the waste lithium battery was disassembled, shredded, sorted and sieved to obtain battery powder and aluminum residue.

(2) Preparation of dawsonite defluorinating agent: based on the step (1), the aluminum residue was finely shredded and passed through a 100-mesh sieve to obtain aluminum residue powder; the obtained aluminum residue powder was mixed with 20% sodium hydroxide solution according to a solid-liquid ratio of 1:4 g/mL, stirred and reacted at 60° C. for 40 min; after the reaction, the solution was filtered to obtain insoluble residue and sodium metaaluminate solution; the insoluble residue was transferred to step (3) for acid leaching and dissolution; the solution was introduced with carbon dioxide gas for reaction at a reaction temperature of 50° C., and a stirring rate of 200 rpm. The stirring and introducing carbon dioxide gas were not stopped until a pH value of the solution stabilized at 6.0, the solution was aged for 3 h, then filtered, and the filter residue was washed twice with pure water; and after dried for 4 hours in a drying oven at 80° C., dawsonite was obtained.

(3) Battery powder leaching and impurity removal: the battery powder obtained from the step (1) was pulped with pure water, and then leached with sulfuric acid and hydrogen peroxide; after impurities removal, 1.8 L of fluorion-containing purified solution was obtained, and the impurities removal comprised adding sodium carbonate to remove iron and aluminum and adding sodium fluoride to remove calcium and magnesium. The components and contents of the fluorion-containing purified solution were shown in Table 3.

TABLE 3
Components and contents of fluorion-
containing purified solution (g/L)

| Ni²⁺ | Co²⁺ | Mn²⁺ | Li⁺ | Na⁺ | F⁻ |
|---|---|---|---|---|---|
| 9.55 | 31.29 | 8.67 | 2.41 | 20.36 | 2.27 |

(4) Selective fluorion removal by adding dawsonite: based on the steps of (2) and (3), to the fluorion-containing purified solution, defluorinating agent dawsonite was added in an amount wherein a molar ratio of aluminum in the dawsonite to fluorion in the purified solution was 1.2:6. At a stirring rate of 150 rpm and temperature of 50° C., 6% sulfuric acid was introduced through a peristaltic pump at a flow rate of 2.0 mL/min, and the reaction was carried out for 75 minutes; an end-point pH value of the reaction was controlled at 5.5; after the reaction, the solution was filtered to obtain 2.7 L of defluorinated solution and filter residue, the defluorinated solution was then subjected to extraction treatment to obtain nickel cobalt manganese sulfate solution product; the filter residue was washed for 2-3 times with hot water to obtain crude sodium hexafluoroaluminate, and the washed water was combined into the defluorinated solution.

(5) Purification of crude sodium hexafluoroaluminate: based on the step (4), the crude sodium hexafluoroaluminate was added to pure water with a solid-liquid ratio of 1:4 g/mL for pulping, and 5% sulfuric acid was added slowly in an agitated state to adjust a pH value of the slurry to 4.0, a small amount of impurities was dissolved; after the reaction, the slurry was filtered to obtain a filter residue, which was then added to pure water for pulping with a solid-liquid ratio of 1:3 g/mL; after filtration, the filter residue was further washed with pure water for pulping with a solid-liquid ratio of 1:3 g/mL once, and filtration was performed to obtain filter residue, which was subjected to drying treatment to obtain high-purity sodium hexafluoroaluminate.

### Comparative Example 1

A method for removing fluorion in the cathode leaching solution of a lithium battery was provided, and the specific process was as follows.

(1) Pretreatment: after discharging, the waste lithium battery was disassembled, shredded, sorted and sieved to obtain battery powder.

(2) Battery powder leaching and impurities removal: the battery powder based on the step (1) was pulped with pure water, and then leached with sulfuric acid and hydrogen peroxide; after impurities removal, 0.6 L of fluorion-containing purified solution was obtained, and impurities removal comprised adding sodium carbonate to remove iron and aluminum and adding sodium fluoride to remove calcium and magnesium. The components and contents of the fluorion-containing purified solution were shown in Table 4.

TABLE 4
Components and contents of fluorion-
containing purified solution (g/L)

| Ni²⁺ | Co²⁺ | Mn²⁺ | Li⁺ | Na⁺ | F⁻ |
|---|---|---|---|---|---|
| 32.53 | 10.47 | 12.82 | 2.49 | 18.49 | 2.32 |

(3) Adding calcium hydroxide to remove fluorion: based on the steps of (2) and (3), to the fluorion-containing purified solution, 3.0 times of a theoretical amount of calcium hydroxide required to react with fluorion was added, and stirred and reacted at 60° C. for 90 minutes; during the reaction, a pH value of the solution was maintained at 5.5 by adding 10% sulfuric acid; and after the reaction, filtration was performed to obtain defluorinated residue and 2.6 L of defluorinated solution.

(4) Purification of defluorinated residue: based on the step (3), to the defluorinated residue, pure water was added to make a slurry; under the conditions of stirring speed of 300 rpm and temperature of 80° C., 10% sulfuric acid was added to adjust a pH value to 1.5, and reacted for 40 min; after the reaction, the solution was filtered to obtain the filtrate and insoluble residue; the insoluble residue was washed twice with pure water; the washing water was combined into the filtrate, and the filtrate was transferred to step (2) for the pulping of battery powder, insoluble residue was washed and dried to obtain purified calcium fluoride.

### Test Example

Table 5 showed the comparison of fluorion removal performance of Examples 1-3 and Comparative Example 1. The specific data was obtained by testing with fluorion ion selective electrode and ICP-AES equipment.

Table 5 Comparison of fluorion removal performance of defluorinating agents in Examples 1-3 and

Comparative example 1

| | Fluorion | Fluorion | Impurity | | | Purity of |
|---|---|---|---|---|---|---|
| | concentration of | concentration of | concentration of | | Fluorion | residue |
| | Fluorion-containing | defluorinated | defluorinated | | removal | after |
| | purified solution | solution | solution | | rate | purification |
| | (g/L) | (g/L) | (g/L) | | (%) | (%) |
| Example 1 | 2.43 | 0.017 | <0.001 | (Al) | 99% | 96% |
| Example 2 | 2.36 | 0.011 | <0.001 | (Al) | 99% | 97% |
| Example 3 | 2.27 | 0.015 | <0.001 | (Al) | 99% | 96% |
| Comparative | 2.32 | 0.069 | 0.32 | (Ca) | 87% | 84% |
| Example 1 | | | | | | |

Among them, the fluorion removal rate

$$η = \frac{{C}_{1} {V}_{1} - {C}_{2} {V}_{2}}{{C}_{1} {V}_{1}} \times 100 \%$$

(C₁ and V₁ are the fluorion concentration and volume of the fluorion-containing purified solution, respectively, and C₂ and V₂ are the fluorion concentration and volume of the defluorinated solution, respectively).

It can be seen from Table 5 that the fluorion concentrations of the defluorinated solutions in the Examples were less than 0.02 g/L, the aluminum ion introduced after fluorion removal was less than 0.001 g/L, and the fluorion removal rate is as high as 99%. After purification, the residue after fluorion removal can be made into sodium hexafluoroaluminate with a purity of up to 97%. Compared with the defluorination by calcium hydroxide in the Comparative Example 1, the fluorion removal effect of the present invention is significantly better. In addition, the purified residue (i.e., calcium fluoride) of Comparative Example 1 in the table has a lower purity. This is because when calcium hydroxide is used to remove fluorion, not only calcium fluoride but also calcium sulfate is generated, therefore the purity of calcium fluoride generated is not high.

The examples of the present invention have been described in detail above with reference to the accompanying drawings. However, the present invention is not limited to the above-mentioned examples. Within the scope of knowledge possessed by those of ordinary skill in the art, various modifications can be made without departing from the purpose of the present invention. In addition, the examples and the features in the examples of the present invention can be combined with each other if there is no conflict.

1. A method for removing fluorion in cathode leaching solution of a lithium battery, comprising the following steps:
S1: adding an acid and an oxidant to battery powder for leaching, and removing impurities from an obtained leaching solution to obtain a fluorion-containing solution; and
S2: adding dawsonite and sulfuric acid to the fluorion-containing solution for reaction under stirring at a certain temperature, performing solid-liquid separation to obtain a defluorinated solution and a filter residue, and washing the filter residue to obtain crude sodium hexafluoroaluminate.

2. The method according to claim 1, wherein in the step S1, removing impurities comprises a step of adding sodium fluoride to remove calcium and magnesium.

3. The method according to claim 1, wherein in the step S2, the dawsonite is prepared by a method comprising the following steps: mixing aluminum powder with a sodium hydroxide solution for reaction, performing filtering to obtain a metaaluminate solution, introducing carbon dioxide gas into the metaaluminate solution for reaction under stirring at a certain temperature until an end-point pH value of a resulting solution is stable in a certain range, then stop stirring, aging the resulting solution for a period of time, and performing filtering to obtain the dawsonite.

4. The method according to claim 3, wherein a solid-liquid ratio of the aluminum powder to the sodium hydroxide solution is 1:(3-5) g/mL, and a concentration of the sodium hydroxide solution is 10% to 30%.

5. The method according to claim 3, wherein the step of introducing carbon dioxide gas into the metaaluminate solution for reaction is conducted at a temperature of 40° C. to 60° C.

6. The method according to claim 1, wherein in the step S2, a molar ratio of aluminum in the dawsonite to fluorion in the fluorion-containing solution is (1-1.3):6.

7. The method according to claim 1, wherein in the step S2, a flow rate of the added sulfuric acid is 1.0 mL/min to 2.5 mL/min, and a mass concentration of the sulfuric acid is 5% to 10%.

8. The method according to claim 1, wherein in the step S2, a reaction of the fluoride-containing solution and the dawsonite is conducted at a temperature of 40° C. to 60° C. for 60 min to 90 min.

9. The method according to claim 1, wherein the step S2 further comprises: pulping the crude sodium hexafluoroaluminate with water, adding an acid to adjust a pH value of a resulting slurry to dissolve a small amount of impurities, and then filtering the slurry, washing and drying an obtained solid to obtain high-purity sodium hexafluoroaluminate.

10. The method of claim 9, wherein the acid is added to adjust the pH value of the resulting slurry to 3.0-5.0.
